(19) United States
(12) Patent Application Publication
(10) Pub. No.: US 2013/0105504 A1
(43) Pub. Date: May 2, 2013

(54) Handle for take-out box

(71) Applicant: Linden H. Bowman, Ellicott City, MD (US)

(72) Inventor: Linden H. Bowman, Ellicott City, MD (US)

(73) Assignee: The Lindy Bowman Company, Elkridge, MD (US)

(21) Appl. No.: 13/282,801

(22) Filed: Oct. 27, 2011

(51) Int. Cl. B65D 79/00; B23P 17/04

(52) U.S. Cl. 220/752; 29/428

(57) ABSTRACT

An embodiment of the invention includes a device comprising a first base proximate a first end of a handgrip, and a first wall-engaging component extending from the first base. The first wall-engaging component includes a first trunk having a bottom end connected to the first base, and a first pair of elongated barbs connected to a top end of the first trunk. The first barbs extend from the top end of the first trunk and towards the first base. A second base is proximate a second end of the handgrip, and a second wall-engaging component extends from the second base. The second wall-engaging component includes a second trunk having a bottom end connected to the second base, and a second pair of elongated barbs connected to a top end of the second trunk. The second barbs extend from the top end of the second trunk and towards the second base.

### I. DESCRIPTION OF THE TECHNICAL FIELD

This invention relates to an improvement in handles for grasping boxes, cartons, bags, and other like containers, and more particularly to a handle having a flat base and wall-engaging means on terminal ends thereof for securing the handle to a container.

### II. BACKGROUND OF THE INVENTION

Boxes, cartons, bags, and the like provide a means for storing and transporting articles of varying shapes and sizes. In addition, decorative boxes provide a quick and easy means for wrapping and presenting a gift to a recipient. However, it is often difficult to grasp or hold a box when the box is full, the contents of the box are heavy, and/or when the size of the box makes holding the box cumbersome. Regardless of whether a box is bulky or small, it may also be difficult to hold multiple box at the same time.

Therefore, handles are often attached to or integrally formed with boxes to facilitate the ease of grasping, holding, and carrying. Although boxes are available in a variety of shapes and styles, boxes and box handles are often formed from inexpensive, light-weight materials. A problem commonly associated with boxes is the tearing or separation of the handle from the box. For example, when a box having heavy contents is lifted by the handles, the box or handle can tear due to inadequate reinforcement at the handle connection points.

### III. SUMMARY OF THE INVENTION

The invention relates to a box and handle combination having a novel structure.

It is an object of the invention to provide a box for storing articles therein and for transporting articles.

It is another object of the invention to provide a decorative box for packaging merchandise for a consumer.

It is yet another object of the invention to provide a decorative box for wrapping and presenting a gift to a recipient.

It is still another object of the invention to provide a handle for grasping/holding the box.

It is still yet another object of the invention to provide a base and wall-engaging means for preventing separation of the handle from the box by engaging the surface of the box at apertures in the sidewalls of the box.

It is a further object of the invention to provide a unique configuration of bases, wall-engaging means, and a handgrip that present a means for carrying the box.

Certain of these and other objects are satisfied by a device comprising a handgrip having a first end and a second end. The device includes a first base proximate the first end of the handgrip, and a first wall-engaging means extending from the first base. The first wall-engaging means includes a first trunk having a bottom end and a top end, wherein the bottom end is connected to the first base. The first wall-engaging means further includes a first pair of elongated barbs connected to the top end of the first trunk, wherein the first barbs extend from the top end of the first trunk and towards the first base.

The device also includes a second base proximate the second end of the handgrip, and a second wall-engaging means extending from the second base. The second wall-engaging means includes a second trunk having a bottom end and a top end, wherein the bottom end is connected to the second base. The second wall-engaging means further includes a second pair of elongated barbs connected to the top end of the second trunk, wherein the second barbs extend from the top end of the second trunk and towards the second base. In at least one embodiment of the invention, the trunk and barbs form an arrowhead-shape configuration, wherein an angle between the trunk and each of the barbs is between 1-89 degrees. In another embodiment, the handgrip, first base, first wall-engaging means, second base, and second wall-engaging means are integrally formed.

The device further comprises a container including a first sidewall having a first aperture and a second sidewall having a second aperture. The trunks are positioned within the apertures such that the barbs are proximate inner surfaces of the sidewalls. Thus, the barbs contact the inner surfaces of the sidewalls when the handgrip is pulled and prevent the wall-engaging means from being pulled out of the container. The bases contact the sidewalls proximate the apertures. In one embodiment, the diameters of the bases are greater than the diameters of the apertures. In another embodiment, the widths of the bases are greater than the widths of the apertures.

For definitional purposes and as applicable, the term “container” as used herein is intended to mean a vessel for storing contents therein, and may be in the form of a box, carton, bag, and the like.

As used herein, the term “handgrip” is intended to mean a flexible elongated member having a length substantially greater than its cross-sectional dimension, and may be in the form of a rod, shaft, dowel, stick, handle, and the like.

As used herein, the term “barb” is intended to mean an elongated tab-like structure, and may be in the form of a flap, strip, bar, rod, dowel, shaft, and the like.

As used herein, “aperture” is intended to mean a feed-through dimensioned to retain portions of the associated handle therein, and may be in the form of an eye, eyelet, hole, opening, orifice, pass-through, passage, perforation, slit, slot, and the like.

As used herein, “proximate” is intended to mean near, adjacent, contiguous, next to, close to, by, on, in contact with, and the like.

As used herein, “connected” is intended to mean attached, engaged, coupled, contacts, linked, affixed, attached, and the like.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawing which is shown by way of illustration to the specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### IV. BRIEF DESCRIPTION OF THE DRAWING

FIG. 1 is a front perspective view of a combination container and handle device according to an embodiment of the invention.

FIG. 2 is a rear view of the combination container and handle device illustrated in FIG. 1.

FIG. 3 is a top cross-sectional view of a sidewall portion of the combination container and handle device illustrated in FIG. 1.

FIG. 4 is a top perspective view of a handle according to an embodiment of the invention.

FIG. 5 is a flow diagram illustrating a method for forming a combination container and handle device according to an embodiment of the invention.

### V. DETAILED DESCRIPTION OF THE EMBODIMENTS

Referring now to the figures, wherein like reference numbers denote like components, elements, or features through the various illustrated embodiments discussed in detail below, the invention is a device including a container and a strap. While specific implementations of the disclosed technology are discussed, it should be understood that this is done for illustration purposes only. A person skilled in the relevant art will recognize that other components and configurations may be used without departing from the spirit and scope of the invention.

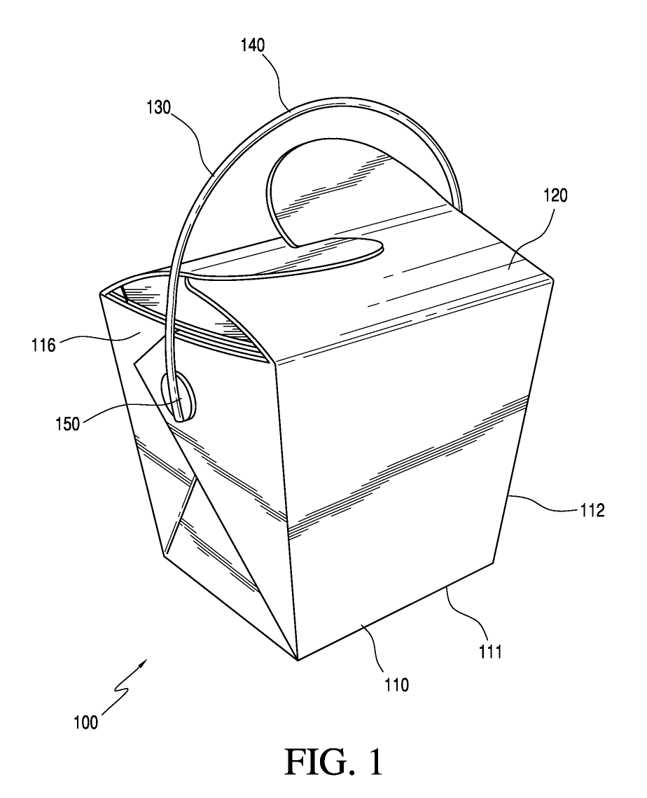

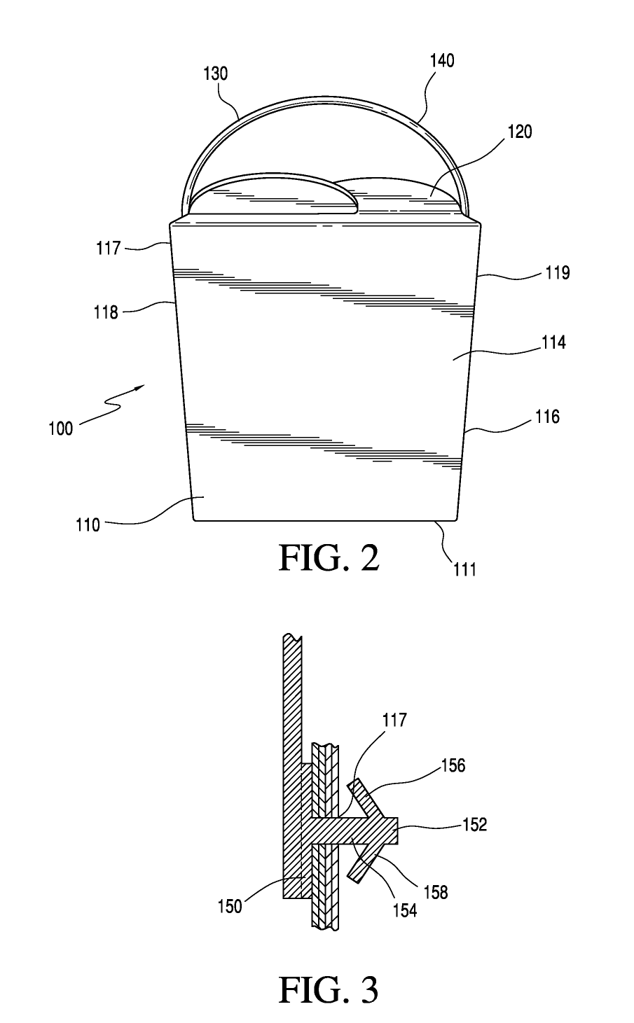

FIGS. 1 and 2 illustrate a device 100 according to an embodiment of the invention. The device 100 includes a container 110 for retaining articles therein, wherein the container 110 includes a bottom 111 connected to a front wall 112, a rear wall 114, a first sidewall 116, a second sidewall 118, and a top 120. In at least one embodiment, the container 110 is formed from a single sheet of foldable material, wherein the first sidewall 116, second sidewall 118, and top 120 each comprise two or more flaps. In another embodiment, the container 110 is formed from multiple separate sheets or panels that are combined (e.g., attached mechanically or via adhesive) to form the bottom 111, front wall 112, rear wall 114, first sidewall 116, second sidewall 118, and top 120.

In at least one embodiment of the invention, the bottom 111, front wall 112, rear wall 114, first sidewall 116, second sidewall 118, and top 120 are quadrilateral-shaped, wherein the front wall 112 and rear wall 114 are equal in size and shape, and wherein the first sidewall 116 and second sidewall 118 are equal in size and shape. In another embodiment, the bottom 111, front wall 112, rear wall 114, first sidewall 116, second sidewall 118, and top 120 have different sizes and shapes, for example, circles, ovals, squares, and/or triangles of varying sizes. In yet another embodiment, the container 110 lacks the bottom 111, front wall 112, rear wall 114, and top 120, wherein the container 110 resembles a pouch, satchel, sack, purse, or the like. The container 110 is formed from semi-rigid organic material, such as, for example, paper, cardboard, fabric and/or leather. In an another embodiment, the container 110 is formed from other materials of varying stiffness/flexibility, for example, plastic, wood, metal, ceramic, and/or glass.

In at least one embodiment of the invention, the first sidewall 116 and second sidewall 118 include circular apertures 117 and 119, respectively, on upper portions thereof. In another embodiment, the apertures 117 and 119 have other shapes, such as, for example, ovals, squares, rectangles, and/or triangles. As illustrated in FIG. 3, the apertures 117 and 119 are dimensioned to receive a portion of a handle therein. In yet another embodiment, the first sidewall 116 and second sidewall 118 includes grommets and/or reinforcement wall(s) to strengthen the structural integrity of the apertures 117 and 119.

The unitary device 100 includes at least one flexible, elongated, plastic handle 130. In another embodiment, the handle 130 is formed from other materials of varying flexibility, such as, for example, metal, nylon, braided cotton fiber, and/or other types of fabric. The handle 130 includes a handgrip 140, a first base 150, a first wall-engaging means 152, a second base 160, and a second wall-engaging means 162. The first base 150 is connected to a first terminal end of the handgrip 140; and, the second base 150 is connected to a second terminal end of the handgrip 140. In at least one embodiment, the handgrip 140, first base 150, first wall-engaging means 152, second base 160, and second wall-engaging means 162 are integrally formed. In another embodiment, the handgrip 140, first base 150, first wall-engaging means 152, second base 160, and second wall-engaging means 162 are separate components that are connected to each other via adhesive, snaps, clips, clasps, ties, and other like fasteners.

In at least one embodiment of the invention, the bases 150 and 160 are flat disks having a circular cross-section. In another embodiment, the bases 150 and 160 have a different cross-sectional shape, for example, ovular, rectangular, or triangular. In yet another embodiment, the bases 150 and 160 are spherical, cylindrical, cubical, or pyramidal. The bases 150 and 160 are dimensioned such that they cannot be pulled through the apertures 117 and 119. Thus, in one embodiment, the diameters of the bases 150 and 160 are greater than the diameters of the apertures 117 and 119. In another embodiment, the widths and/or lengths of the bases 150 and 160 are greater than the widths and/or lengths of the apertures 117 and 119. As used herein, the term “diameter” is meant to include the horizontal dimension, vertical dimension, and diagonal dimension of the base and/or aperture. As used herein, the term “width” is meant to include the horizontal dimension, vertical dimension, and diagonal dimension of a cross-section of the base and/or aperture. When the handle 130 is connected to the container 110, the bases 150 and 160 rest on the outer surfaces of the first sidewall 116 and second sidewall 118, respectively.

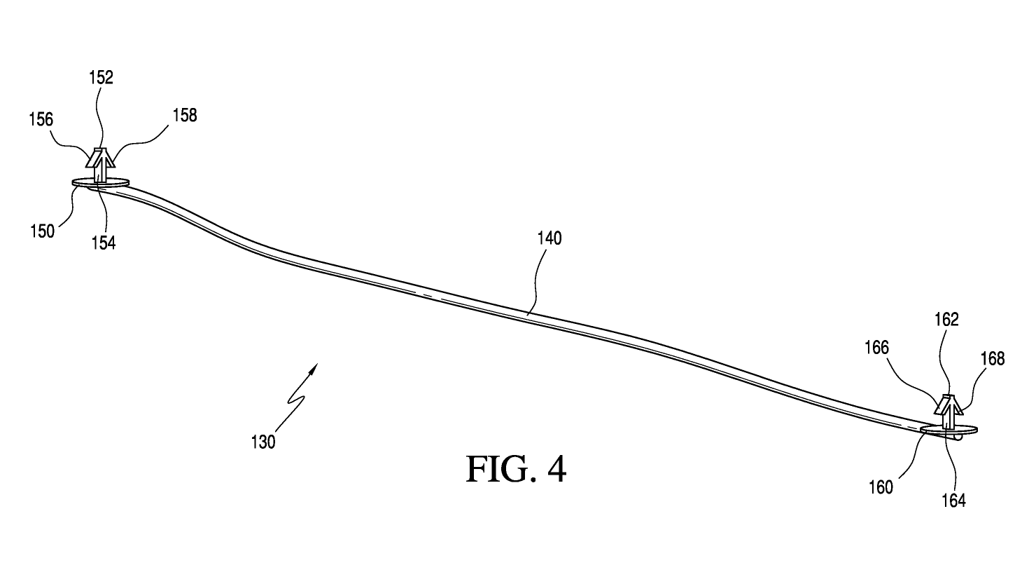

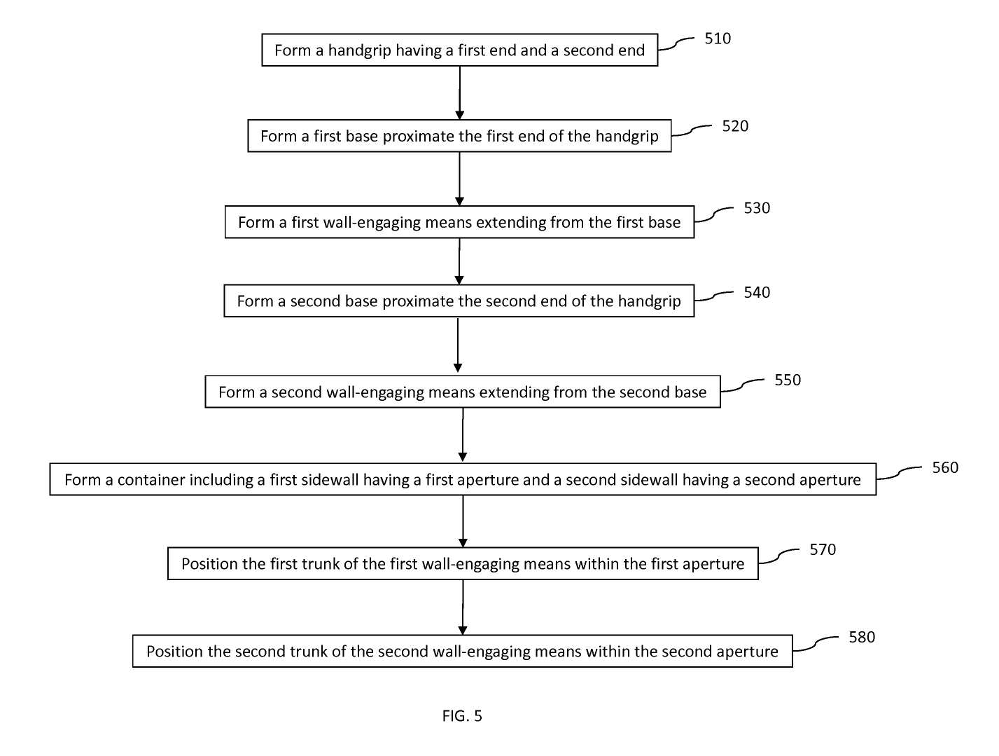

As illustrated in FIG. 4, the first wall-engaging means 152 (also referred to herein as the first wall-engaging component) extends outwardly from the first base 150. The second wall-engaging means 162 (also referred to herein as the second wall-engaging component) extends outwardly from the second base 160. The first wall-engaging means 152 includes a trunk 154, wherein a bottom end of the trunk 154 is connected to the first base, and wherein the top end of the trunk 154 is connected to barbs 156 and 158.

The trunk 154 and barbs 156 and 158 are elongated bar-like structures having rectangular cross-sections. In another embodiment, the trunk 154 and barbs 156 and 158 each have a different shape, such as a cylinder. As illustrated in FIGS. 2-3, the trunk 154 and barbs 156 and 158 form an arrowhead-shape configuration, wherein the barbs 156 and 158 extend from the top end of the trunk 154 and towards the base 150 at an acute angle (e.g., 45 degrees). In other words, the angle between the trunk 154 and each of the barbs 156 is less than orthogonal and greater than parallel. Preferably, the angle between the trunk 154 and each of the barbs 156 and 158 is between 30-60 degrees, and more preferably at an angle between 40-50 degrees. The second wall-engaging means 162 is identical to the first wall-engaging means 152, and includes a trunk 164 and barbs 166 and 168.

The trunks 154 and 164 are positioned within the apertures 117 and 119, respectively, such that the first barbs 156 and 158 are proximate an inner surface of the first sidewall 116, and such that the second barbs 166 and 168 are proximate an inner surface of the second sidewall 118. When the handgrip 140 is pulled, the first barbs 156 and 158 contact the inner surface of the first wall 116; and, the second barbs 166 and 168 contact the inner surface of the second wall 118.

In another embodiment, the container lacks a top 120, wherein the trunks 154 and 164 are positioned within the apertures 117 and 119, respectively, such that the first barbs 156 and 158 are proximate an outer surface of the first sidewall 116, and such that the second barbs 166 and 168 are proximate an outer surface of the second sidewall 118. When the handgrip 140 is pulled, the first barbs 156 and 158 contact the outer surface of the first wall 116; and, the second barbs 166 and 168 contact the outer surface of the second wall 118. The first base 150 and second base 160 contact inner surfaces of the first sidewall 116 and second sidewall 118, respectively.

Therefore, the barbs prevent dislodgement of the handgrip 140 from the container 110, thereby securing the handle 130 to the container 110. Specifically, the first barbs 156 and 158 prevent the first end of the handgrip 140 from being pulled away from the container 110 through the first aperture 117; and, the second barbs 166 and 168 prevent the second end of the handgrip 140 from being pulled away from the container 110 through the second aperture 119.

The width of the wall-engaging means (i.e., the distance between the tips of two barbs connected at the top end of a trunk) is greater than the diameter/width of the aperture. However, the swept back orientation (i.e., the arrow-head shaped configuration of the wall engaging means) and semi-rigid properties of the barbs allow a wall-engaging means to be inserted into an aperture while also preventing the wall-engaging means from being pulled out through the aperture.

FIG. 5 is a flow diagram illustrating a method of manufacturing a device according to an embodiment of the invention. A handgrip having a first end and a second end is formed 510; and, a first base is formed proximate the first end of the handgrip 520. A first wall-engaging means extending from the first base is formed 530. This includes forming a first trunk having a bottom end and a top end such that the bottom is connected to the first base. The forming of the first wall-engaging means further includes forming a first pair of elongated barbs connected to the top end of the first trunk such that the first barbs extend from the top end of the first trunk and towards the first base.

A second base is formed proximate the second end of the handgrip 540; and, a second wall-engaging means extending from the second base is formed 550. This includes forming a second trunk having a bottom end and a top end such that the bottom end is connected to the second base. The forming of the second wall-engaging means further includes forming a second pair of elongated barbs connected to the top end of the second trunk such that the second barbs extend from the top end of the second trunk and towards the second base.

A container is formed 560 which includes forming a first sidewall having a first aperture, and forming a second sidewall having a second aperture. The first trunk is positioned within the first aperture 570 such that the first barbs are proximate an inner surface of the first sidewall, and such that the first base is positioned proximate an outer surface of the first sidewall. The second trunk is positioned within the second aperture 580 such that the second barbs are proximate an inner surface of the second sidewall, and such that the second base is positioned proximate an outer surface of the second sidewall.

Although specific example embodiments have been illustrated and described herein, those of ordinary skill in the art appreciate that other variations, aspects, or embodiments may be contemplated, and/or practiced without departing from the scope or the spirit of the appended claims.

1. A device comprising:
a handgrip comprising a first end and a second end;
a first base proximate said first end of said handgrip, said first base comprising a disk;
a first wall-engaging means extending from said first base, said first wall-engaging means comprising:
a first trunk comprising a bottom end and a top end, said bottom end being connected to said first base, and
a first pair of elongated barbs connected to said top end of said first trunk, said first barbs extend from said top end of said first trunk and towards said first base;
a second base proximate said second end of said handgrip, said second base comprising a disk; and
a second wall-engaging means extending from said second base, said second wall-engaging means comprising:
a second trunk comprising a bottom end and a top end, said bottom end being connected to said second base, and
a second pair of elongated barbs connected to said top end of said second trunk, said second barbs extend from said top end of said second trunk and towards said second base.

2. The device according to claim 1, wherein said first trunk and said first barbs form a first arrowhead-shape configuration, and wherein said second trunk and said second barbs form a second arrowhead-shape configuration.

3. The device according to claim 1, wherein an angle between said first trunk and each of said first barbs is between 30-60 degrees and wherein an angle between said second trunk and each of said second barbs is between 30-60 degrees.

4. The device according to claim 1, further comprising a container comprising:
a first sidewall comprising a first aperture; and
a second sidewall comprising a second aperture,
wherein said first trunk is positioned within said first aperture such that said first barbs are proximate an inner surface of said first sidewall, and
wherein said second trunk is positioned within said second aperture such that said second barbs are proximate an inner surface of said second sidewall.

5. The device according to claim 4, wherein said first barbs contact said inner surface of said first sidewall when said handgrip is pulled, and wherein said second barbs contact said inner surface of said second sidewall when said handgrip is pulled.

6. The device according to claim 4, wherein said first barbs prevent said first wall-engaging means from being pulled out of said container through said first aperture, and wherein said second barbs prevent said second wall-engaging means from being pulled out of said container through said second aperture.

7. The device according to claim 4, wherein said first base contacts said first sidewall proximate said first aperture, and wherein said second base contacts said second sidewall proximate said second aperture.

8. The device according to claim 4, wherein a diameter of said first base is greater than a diameter of said first aperture, and wherein a diameter of said second base is greater than a diameter of said second aperture.

9. The device according to claim 4, wherein a width of said first base is greater than a width of said first aperture, and wherein a width of said second base is greater than a width of said second aperture.

10. The device according to claim 1, wherein said handgrip, said first base, said first wall-engaging means, said second base, and said second wall-engaging means are integrally formed.

11. A device comprising:
a handgrip comprising a first end and a second end;
a first base proximate said first end of said handgrip, said first base comprising a disk;
a first wall-engaging component extending from said first base, said first wall-engaging component comprising:
a first trunk comprising a bottom end and a top end, said bottom end being connected to said first base, and
a first pair of elongated barbs connected to said top end of said first trunk, said first barbs extend from said top end of said first trunk and towards said first base at an acute angle relative to said first trunk;
a second base proximate said second end of said handgrip, said second base comprising a disk;
a second wall-engaging component extending from said second base, said second wall-engaging component comprising:
a second trunk comprising a bottom end and a top end, said bottom end being connected to said second base, and
a second pair of elongated barbs connected to said top end of said second trunk, said second barbs extend from said top end of said second trunk and towards said second base at an acute angle relative to said second trunk; and
a container comprising:
a first sidewall comprising a first aperture, said first trunk is positioned within said first aperture such that said first barbs are proximate an inner surface of said first sidewall, and
a second sidewall comprising a second aperture, said second trunk is positioned within said second aperture such that said second barbs are proximate an inner surface of said second sidewall.

12. The device according to claim 11, wherein said first trunk and said first barbs form a first arrowhead-shape configuration, and wherein said second trunk and said second barbs form a second arrowhead-shape configuration.

13. The device according to claim 11, wherein an angle between said first trunk and each of said first barbs is between 40-50 degrees and wherein an angle between said second trunk and each of said second barbs is between 40-50 degrees.

14. The device according to claim 11, wherein said first barbs contact said inner surface of said first sidewall when said handgrip is pulled, and wherein said second barbs contact said inner surface of said second sidewall when said handgrip is pulled.

15. The device according to claim 11, wherein said first barbs prevent said first wall-engaging component from being pulled out of said container through said first aperture, and wherein said second barbs prevent said second wall-engaging component from being pulled out of said container through said second aperture.

16. The device according to claim 11, wherein said first base contacts said first sidewall proximate said first aperture, wherein a diameter of said first base is greater than a diameter of said first aperture,
wherein said second base contacts said second sidewall proximate said second aperture, and wherein a diameter of said second base is greater than a diameter of said second aperture.

17. A method comprising:
forming a handgrip comprising a first end and a second end;
forming a first base proximate the first end of the handgrip, the first base comprising a disk;
forming a first wall-engaging means extending from the first base, said forming of the first wall-engaging means comprising:
forming a first trunk comprising a bottom end and a top end such that the bottom is connected to the first base, and
forming a first pair of elongated barbs connected to the top end of the first trunk such that the first barbs extend from the top end of the first trunk and towards the first base;
forming a second base proximate the second end of the handgrip, the second base comprising a disk; and
forming a second wall-engaging means extending from the second base, said forming of the second wall-engaging means comprising:
forming a second trunk comprising a bottom end and a top end such that the bottom end is connected to the second base, and
forming a second pair of elongated barbs connected to the top end of the second trunk such that the second barbs extend from the top end of the second trunk and towards the second base.

18. The method according to claim 17, further comprising a forming a container comprising:
forming a first sidewall comprising a first aperture; and
forming a second sidewall comprising a second aperture.

19-20. (canceled)

21. The device according to claim 4, wherein said first base and said second base each comprise a disk.

22. The device according to claim 4, wherein said first barbs comprise first end tips, wherein said first end tips of said first barbs contact said inner surface of said first sidewall when said handgrip is pulled,
wherein said second barbs comprise second end tips, and wherein said second end tips of said second barbs contact said inner surface of said second sidewall when said handgrip is pulled.
